(19) United States
(12) Patent Application Publication
(10) Pub. No.: US 2020/0062279 A1
(43) Pub. Date: Feb. 27, 2020

(54) METHOD AND DEVICE FOR INFORMING THE DRIVER OF A MOTOR VEHICLE EQUIPPED WITH A WHEEL SLIP CONTROL SYSTEM

(71) Applicant: Robert Bosch GmbH, Stuttgart (DE)

(72) Inventor: Michael Hund, Ludwigsburg (DE)

(21) Appl. No.: 16/545,957

(22) Filed: Aug. 20, 2019

(30) Foreign Application Priority Data
Aug. 21, 2018 (DE) 102018214116.9

(51) Int. Cl. B60W 50/16; B60W 30/18; B60W 30/12

(52) U.S. Cl. CPC B60W 50/16; B60W 2050/143; B60W 30/12; B60W 30/18172

(57) ABSTRACT

A method for informing the driver of a motor vehicle equipped with a wheel slip control system about the instantaneous existence of an intervention or an imminent intervention of the wheel slip control system. The driver is informed via an activation of an information provider of a driving safety system or driving comfort system independent of the wheel slip control system.

### BACKGROUND INFORMATION

German Published Patent Application No. 10 2009 041 198 teaches a display instrument and a method for displaying the driving stability of a vehicle, using which a control status of at least one system assisting the driving stability is gradually displayable as a measure of the driving stability.

### SUMMARY

The present invention relates to a method for informing a driver of a motor vehicle equipped with a wheel slip control system about the instantaneous existence of an intervention or an imminent intervention of the wheel slip control system. The core of the present invention is that the act of informing the driver is carried out via an activation of an information provider or information system of a driving safety system or driving comfort system independent of the wheel slip control system. An imminent intervention of the wheel slip control system may be recognized, for example, in that the recognized existing driving situation is found to be just short of the intervention threshold of the wheel slip control system.

One advantageous embodiment of the present invention is characterized in that the wheel slip control system is a brake slip control system.

One advantageous embodiment of the present invention is characterized in that the brake slip control system is an antilock braking system or a vehicle dynamics control system.

One advantageous embodiment of the present invention is characterized in that the driving safety system is an electrically assisted steering system or a lane keeping assist system and the driver is informed by a vibration of the steering wheel.

One advantageous embodiment of the present invention is characterized in that the driving comfort system is an audio system and the driver information is acoustic information.

One advantageous embodiment of the present invention is characterized in that the driving comfort system is a massage seat and the driver is informed by haptic feedback by the massage seat.

One advantageous embodiment of the present invention is characterized in that the activation of the information provider in the case of the instantaneous presence of an intervention of the antilock braking system may be deactivated on the part of the driver or on the part of a repair shop.

Furthermore, the present invention includes a device containing means which are designed to carry out the method according to the present invention. This is in particular a control unit in which the program code for carrying out the method according to the present invention is stored.

### BRIEF DESCRIPTION OF THE DRAWING

The FIGURE shows the basic sequence of the method according to the present invention.

### DETAILED DESCRIPTION

During an ABS control, a direct feedback about the existence of the ABS control takes place via jerking of the brake pedal using brake systems coupled to the brake pedal. The driver thereupon knows that the ABS system is instantaneously active and he is moving in a vehicle-dynamics limiting range. This feedback during braking is partially used by drivers as information about the friction coefficient of the roadway and signals to the driver that he is already moving at the friction coefficient limit with the present brake application.

This feedback no longer takes place in the case of decoupled brake systems, for example, in the case of brake-by-wire systems. An existing ABS intervention is no longer perceptible via the driver's foot on the brake pedal. A simulation of this feedback with the aid of a haptic actuator attached to the brake pedal entails additional costs. Since modern motor vehicles include, in addition to the antilock braking system, further driving safety systems or driving comfort systems independent thereof, it is possible to also use the signaling devices provided in any case in these further systems for signaling the existence of ABS braking. Also using the signaling devices of an electrically assisted steering system or a lane keeping assist system suggest themselves as examples, which may be used in the case of ABS braking for steering wheel vibration. Suitable alerts or warning noises may also be generated in an audio system provided in the vehicle or the vibration of a massage seat may be activated.

In addition to the mentioned signals, an optical information notification in the instrument cluster may also be provided.

The function may be able to be deactivated by an automobile repair shop and/or the driver if the driver perceives it to be annoying.

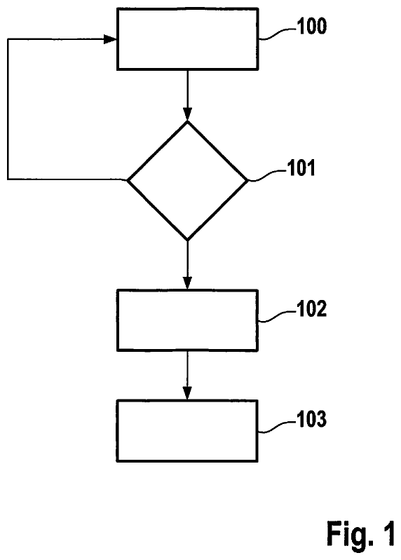

The fundamental sequence of the method according to the present invention is shown in FIG. 1. After the start of the method in block 100, it is ascertained in block 101 whether an intervention or an imminent intervention of the wheel slip control system exists. If this is not the case, the sequence returns to block 100. However, if an intervention or an imminent intervention of the wheel slip control system exists, informing of the driver via an activation of an information provider of a driving safety system or driving comfort system independent of the wheel slip control system is carried out in block 102. The method ends in block 103.

What is claimed is:

1. A method for informing a driver of a vehicle equipped with a wheel slip control system about an instantaneous existence of an intervention or an imminent intervention of the wheel slip control system, comprising:
informing the driver via an activation of an information provider of a driving safety system or vehicle comfort system independent of the wheel slip control system.

2. The method as recited in claim 1, wherein the wheel slip control system is a brake slip control system.

3. The method as recited in claim 2, wherein the wheel slip control system is an antilock braking system or a vehicle dynamics control system.

4. The method as recited in claim 1, wherein the driving safety system is an electrically assisted steering system or a lane keeping assist system, and wherein the driver is informed a vibration of a steering wheel.

5. The method as recited in claim 1, wherein the vehicle comfort system is an audio system, and wherein a driver information is acoustic information.

6. The method as recited in claim 1, wherein the vehicle comfort system is a massage seat, and wherein the driver is informed by haptic feedback by the massage seat.

7. The method as recited in claim 2, wherein the activation of the information provider in case of the instantaneous existence of the intervention of the antilock braking system may be deactivated on the part of the driver or on the part of a repair shop.

8. A device for informing a driver of a vehicle equipped with a wheel slip control system about an instantaneous existence of an intervention or an imminent intervention of the wheel slip control system, comprising:
an arrangement for informing the driver via an activation of an information provider of a driving safety system or vehicle comfort system independent of the wheel slip control system.
